(19) United States
(12) Patent Application Publication
(10) Pub. No.: US 2026/0300300 A1
(43) Pub. Date: Oct. 1, 2026

(54) GENERATING LOCATION-BASED RESPONSES BASED ON MULTIMODAL EMBEDDINGS AND GENERATIVE ARTIFICIAL INTELLIGENCE (AI) MODELS

(71) Applicant: Microsoft Technology Licensing, LLC, Redmond, WA (US)

(72) Inventors: Ming TAN, Bellevue, WA (US); Hamideh REZAEE, Kirkland, WA (US); Pak Kiu CHUNG, Sammamish, WA (US); Nikola LETIC, Belgrade (RS); Jieren DENG, Redmond, WA (US); Marius Alexandru MARIN, Bellevue, WA (US); Andrew Blair WOIZESKO, Seattle, WA (US); Ravi PRAKASH, Redmond, WA (US)

(21) Appl. No.: 19/096,285

(22) Filed: Mar. 31, 2025

(51) Int. Cl. G06F 16/2457; G06V 10/40; G06V 10/75

(52) U.S. Cl. CPC G06F 16/24575; G06V 10/40; G06V 10/751

(57) ABSTRACT

This disclosure describes a location-based response system that utilizes multimodal embedding and generative artificial intelligence (AI) models to generate location-based responses for user queries. For example, the location-based response system receives a real-time image, real-time location data, and a user query from a client device and determines a multimodal embedding in a multimodal vector embedding space based on the real-time image and the real-time location data. The multimodal embedding is then provided to a generative AI model, together with the data received from the client device, with instructions to generate a user query response. Upon receiving the user query response from the generative AI model, the system may provide it to the client device. Indeed, the location-based response system generates location-based responses for user queries by utilizing identified multimodal embedding and by instructing a generative AI model to respond to the user query based on the identified multimodal embedding.

### CROSS-REFERENCE AND RELATED APPLICATIONS

N/A

### BACKGROUND

Location-based services have become integral to modern technology, leveraging geospatial data to provide a wide range of services and information to users. For example, many existing systems utilize location-based services to enhance user engagement by providing location-specific recommendations and services. Despite modern advances, existing systems still face challenges when providing location-based services.

### BRIEF DESCRIPTION OF THE DRAWINGS

The following detailed description provides specific and detailed implementations accompanied by drawings. Additionally, each of the figures listed below corresponds to one or more implementations discussed in this disclosure.

FIG. 1 illustrates an example overview diagram of a location-based response system generating location-based responses based on location-specific multimodal embeddings using one or more generative artificial intelligence (AI) models.

FIG. 2 illustrates an example diagram of a computing environment in which the location-based response system is implemented.

FIG. 3 illustrates an example diagram of generating a multimodal embedding in multimodal vector embedding space.

FIG. 4 illustrates an example sequence diagram for determining visually-influenced user query responses based on real-time user input of a location-based multimodal embedding and a generative AI model.

FIG. 5 illustrates an example sequence diagram for determining visually-influenced user query responses based on natural language narratives of a location-based multimodal embedding and a generative AI model.

FIG. 6 illustrates an example sequence diagram for determining visually-influenced user query responses based on directly embedding a location-based multimodal embedding into a generative AI model.

FIG. 7 illustrates an example state diagram for identifying external location-based information used to generate a visually-influenced response to a user query.

FIG. 8 illustrates an example graphical user interface of providing a visually-influenced response to a user query.

FIG. 9 illustrates an example series of acts in a computer-implemented method for generating location-based responses from multimodal embeddings using generative AI models.

FIG. 10 illustrates example components included within a computer system for implementing location-based response system.

### DETAILED DESCRIPTION

This disclosure describes a location-based response system that utilizes multimodal embeddings and generative artificial intelligence (AI) models to generate visually-influenced, location-based responses to user queries. In various implementations, the location-based response system uses a combination of neural networks and generative AI models to generate accurate responses to location-based queries, including visually influenced navigational responses. To illustrate, in various implementations, the location-based response system receives relevant real-time user input (e.g., a user query, real-time location data, and/or real-time images), uses the real-time user input to retrieve contextual rich location-based information in the form of a multimodal embedding, and provides the real-time user input and the multimodal embedding to a generative AI model to generate relevant location-based responses. Furthermore, the location-based response system can provide the multimodal embedding to the generative AI model as a natural language narrative or feature vectors, along with instructions on how to efficiently utilize the multimodal embedding in generating a user response. In some instances, the location-based responses provide visually-influenced navigational cues to guide users to a requested destination as well as provide visual course corrections.

Accordingly, implementations of the present disclosure provide benefits and solve problems in the art with systems, computer-readable media, and computer-implemented methods that utilize various multimodal embeddings, neural networks, and generative AI models to improve the efficiency, accuracy, and flexibility of generating location-based user query responses. As mentioned above, the location-based response system utilizes real-time user input to pinpoint one or more multimodal embeddings corresponding to a user's location. The location-based response system provides the real-time user input and multimodal embedding information to a generative AI model to generate improved user query responses that are influenced by the visual information included in the multimodal embeddings specific to the particular location (e.g., generate visually-influenced query response).

To illustrate, in various implementations, in response to receiving real-time input data, such as a real-time image, and real-time location data, the location-based response generation system determines a multimodal embedding in multimodal vector embedding space associated with the received real-time input data. The location-based response generation system can provide the multimodal embedding, the real-time input data, and a user query to a generative AI model, where the user query instructs the generative AI model to generate a user query response based on the multimodal embedding. In some instances, the multimodal embedding is represented as a natural language narrative for the generative AI model to ingest. In some instances, the multimodal embedding is directly injected into the generative AI model.

In various implementations, the location-based response system provides visually-influenced navigations based on multimodal embeddings. For example, the location-based response system can use a set of multimodal embedding along a navigational path to guide a user between locations. Furthermore, the location-based response system can compare real-time images along the user's journey to the set of multimodal embedding to determine whether the user is traveling in the correct directions based on visual cues.

The location-based response system provides several technical benefits over existing systems. For example, many existing systems often provide suboptimal results for location-based queries due to their inability to fully contextualize nuances of location-based data used to provide responses. This limitation frequently necessitates additional user queries, thereby increasing computational resource consumption. Furthermore, the lack of rich location-based context, or independent information from multiple sources, can cause issues while trying to provide navigational assistance to users, such as providing suboptimal navigational instructions due to not understanding a user's precise location or heading.

Recent advancements have seen the integration of large language models (LLMs) in some systems to address location-based queries. Despite this, LLMs also struggle with the lack of contextual location information, leading to inaccuracies in their responses.

As described in this disclosure, the location-based response system provides several significant technical benefits in terms of improved computing efficiency, accuracy, and flexibility compared to existing systems. Moreover, the location-based response system provides several practical applications that address problems related to providing location-based responses to user queries.

When a traditional generative AI model is provided with a user query with an image of a current location, the generative AI model may use a large amount of computational resources to determine at what geographical location the image was taken. Furthermore, even if the generative AI model is able to recognize the approximate geographical location based on recognizable features on the image, the generative AI model might not be able to provide additional information relating to the location.

In contrast, the location-based response system provides contextually-rich information about the queried location when requesting a user query response from a generative AI model. To elaborate, before providing a user query with an image of a current location to a generative AI model, the location-based response system first identifies the user's real-time location. Additionally, using the real-time input data, the location-based response system identifies a multimodal embedding that corresponds to the user's current location. In particular, the multimodal embedding includes contextually-rich information about the current location, drawn from one or more data sources and data types. The location-based response system provides the identified multimodal embedding to the generative AI model, which uses it to generate a better response to the user query.

As mentioned, the location-based response system can improve the efficiency of computing systems. For example, by providing a multimodal embedding of a user's current location, the generative AI model can utilize the provided information to more efficiently generate a user query response. Indeed, rather than trying to search through broad memory stores or make calls to outside sources whose data may be inaccurate, the generative AI model utilizes multimodal embedding to quickly and accurately generate responses to the user query. Furthermore, because the multimodal embedding provides contextual, nuanced information for the provided image, the generative AI model can focus its processing capacity on using the visual context information to influence the query response.

Additionally, some existing systems perform poorly at providing accurate navigational instructions on a local level, such as users walking, biking, or scootering between locations. To elaborate, traditional navigational instructions can include a map showing a route between the user's current (or starting) location and the destination point. These navigational instructions can also include turn-by-turn directions the user will need to make and/or the distance between each turn. When a user is not moving, it may be hard for the user to interpret which direction to head, especially if they are in an unfamiliar location. This may be even harder if the user is traveling in a location with unfamiliar foreign writing, making it difficult to interpret street, store, or business names.

Accordingly, the location-based response system improves accuracy by providing query responses that include visually-influenced directions that are easy to interpret, even without using a map. For example, a user query may be “Where is Book Shop B” and provided along with a real-time image showing Bank A. Upon identifying the user's current location, the location-based response system utilizes the real-time image and/or the current location to fetch a multimodal embedding generated based on multiple modality inputs. The generative AI model may use the multimodal embedding to interpret the location of Book Shop B, which is used to provide navigational directions.

Furthermore, the location-based response system can obtain multimodal embedding along the route between Bank A and Book Shop B to identify visual features the user should encounter along the way. In particular, the location-based response system can use a stream of real-time images to compare visual features the user is currently encountering with expected visual features included in the set of multimodal embeddings along the route. The location-based response system can provide course confirmations when visual features match or corrections when the user encounters visual features not expected based on the visual information included in the set of multimodal embeddings For example, the location-based response system utilizes the combination of real-time images and multimodal embedding visual features to understand the orientation of the user and provides a response saying, “The building in front of you is Bank A and Book Shop B is behind you.”

In various implementations, the location-based response system provides improved flexibility to computing systems. For example, as described above, many existing systems are limited in the type and amount of information they can provide to users in response to a user query that includes a real-time image. Indeed, because of various limitations, these systems are rigid in their responses, which causes the responses often to be inadequate. In contrast, the location-based response system improves flexibility by identifying and providing multimodal embedding for current locations to generative AI models, which use this input information to provide improved location-based insights in response to user queries about images of current locations.

As illustrated in the foregoing discussion, this disclosure utilizes a variety of example terms to describe the features and advantages of one or more implementations. For instance, this disclosure describes the location-based response generation system in the context of a cloud computing system. As an example, the term “cloud computing system” refers to a network of interconnected computing devices that provide various services and applications to computing devices (e.g., server devices and client devices) inside or outside of the cloud computing system. While various components are described as belonging to a cloud computing system, in some implementations, one or more components may be located outside of the cloud computing system. Additional terms are defined throughout the document in different examples and contexts.

As an example, the term “real-time image” refers to a still image, a video, or an image stream typically captured by a camera of a client device. A real-time image may refer to a single image frame or multiple image frames in a video or image stream. In some instances, a real-time image is tied to a location. For instance, a real-time image includes an image captured at a user's current location. In various implementations, real-time images are sent instantaneously (e.g., as a photo taken in connection with the user query or as part of an image stream), or shortly after being captured. In some cases, a real-time image is sent within seconds or minutes before a user provides a user query that includes, or is associated with, the image. In some cases, a real-time image is sent within seconds or minutes after a user provides a user query.

In various implementations, a real-time image captures the immediate field-of-view (FoV) of the client device of the user at their current location. In this way, a real-time image represents the immediate environment of the user associated with the user query. For example, a real-time image may include manmade structures, (such as buildings, bridges, roads, street signs, business names and logos, walls, fences, etc.), natural structures (such as rivers, lakes, oceans, trees, forests, hills, mountains, ridges, etc.), or movable objects (such as people, vehicles, animals, etc.). Indeed, real-time image data can include visually-rich information of a captured environment and, in some instances, can be refined by using surrounding visual features such as buildings and landmarks.

As another example, the term “real-time location data” refers to the current location of a user as captured by one or more client devices associated with the user. In some instances, real-time location data includes global positioning system (GPS) data, which can indicate precise latitude and longitude coordinates. In various instances, real-time location data includes cellular network location data, which can indicate an estimated location using a cell tower triangulation method. In some instances, real-time location data includes Wi-Fi location data, which can indicate a location based on nearby Wi-Fi networks. Real-time location data can also include location data based on Bluetooth location data, IP address location data, address data, or other types of location data. Real-time location data may be fetched and/or updated at regular intervals (e.g., every second or five seconds) or on demand. Additionally, when a real-time image is captured, real-time location data may be stored as metadata in the image file.

As another example, the term “multimodal embedding” refers to a unified representation of data from multiple modalities (i.e., inputs of different file or format types). Modalities may include text, images, audio, structured data, tables, charts, graphics, and other types of data files and formats. A multimodal embedding may be represented as a mathematical vector in multimodal vector embedding space. Multimodal vector embedding space allows multiple multimodal embeddings to be represented in a shared vector space such that two or more multimodal embeddings sharing similar data points are placed closer together in the multimodal vector embedding space.

As an example, the term “machine-learning model” refers to a computer model or computer representation that can be trained (e.g., optimized) based on inputs to approximate unknown functions. For instance, a machine-learning model can include (but is not limited to) an autoencoder model, an embedding model, a classification model, a neural network, a decision tree (e.g., a gradient-boosted decision tree), a linear regression model, a logistic regression model, or a combination of these models.

As another example, the term “neural network” refers to a machine learning model made up of interconnected artificial neurons that communicate and learn to approximate complex functions. Neural networks generate outputs based on multiple inputs provided to the model. For instance, a neural network includes an algorithm (or set of algorithms) that uses deep learning techniques and training data to adjust the parameters of the network and model high-level abstractions in data. Compared to generative AI models, machine learning models and neural networks use fewer parameters and are more computationally efficient. There are various types of neural networks, including transformer-based neural networks, convolutional neural networks (CNNs), embedding neural networks, residual learning neural networks, recurrent neural networks (RNNs), generative neural networks, generative adversarial neural networks (GANs), contrast learning neural networks, and single-shot detection (SSD) networks.

As an example, the term “generative artificial intelligence model” (or “generative AI model”) refers to an artificial intelligence computational system that utilizes deep learning and a large number of parameters (e.g., in the billions or trillions for a large version and fewer for a small version) that are trained on one or more extensive datasets to produce coherent, contextually relevant, and fluent topic-specific outputs (e.g., text and/or images). In many instances, a generative AI model refers to an advanced computational system that uses natural language processing, machine learning, and/or image processing to generate coherent and contextually relevant human-like responses.

Generative AI models have applications in natural language understanding, content generation, text summarization, dialogue systems, language translation, creative writing assistance, image generation, audio generation, and more. A single generative AI model often performs a wide range of tasks by receiving different inputs, such as prompts (e.g., input instructions, rules, example inputs, example outputs, and/or tasks), data, and/or access to data. In response, the generative AI model generates various output formats, ranging from one-word answers to long narratives, images, and videos, labeled datasets, documents, tables, and presentations.

Moreover, generative AI models are primarily based on transformer architectures for understanding, generating, and manipulating human language. Generative AI models can also utilize other types of architectures, such as recurrent neural network (RNN) architectures, long short-term memory (LSTM) architectures, or convolutional neural network (CNN) architectures. Examples of generative AI models include generative pre-trained transformer (GPT) models like GPT-3.5, GPT-4, and GPT-4o; bidirectional encoder representations from transformers (BERT) models; text-to-text transfer transformer models like T5; conditional transformer language (CTRL) models; and Turing-NLG. Other types of generative AI models include sequence-to-sequence models (Seq2Seq), vanilla RNNs, and LSTM networks. In some instances, a generative AI model includes a large language model (LLM), a small language model (SLM), and a small action model (SAM), which serves as a text-based version of a generative AI model that receives text prompts and/or generates text outputs. In various implementations, a generative AI model may function as a multimodal generative model that receives multiple input formats (e.g., text, images, video, data structures) and/or generates multiple output formats.

As another example, the terms “user query” or “query” refer to a question that a user of a client device directly or indirectly provides to a generative AI system. The query may be submitted in the form of text, audio, or other formats. In general, a user query includes an image of a user's current (i.e., real-time) location captured by the user's client device. For example, the query may include a real-time image and a request to answer a question, such as “Where is the closest bookstore?” In another example, the query may be a request to provide recommendations, such as “Suggest a nice restaurant near me” along with providing a real-time image. In various embodiments, a query may be complemented with additional data and attachments provided by the user and/or the client device, such as the current location of the user at the time of the user query.

As another example, the terms “query response” or “response” refer to the generated output produced by a generative AI model in reaction to a given query. A response can take various forms, such as natural language text, images, or other structured data. In various implementations, a user query is visually influenced by the real-time image and/or multimodal embedding data of a user's current location. Indeed, in various implementations, a user query includes visual cues and features used to answer the user query.

As an example, the terms “prompt,” “model prompt,” or “generative AI model prompt” refer to a request made to a generative AI model to create a generative AI model output based on plain language guidance. In some instances, the suggestion item system provides additional information along with a prompt. A prompt can include important contextual information and/or general framing information to ensure that the generative AI model understands the correct context, syntax, and grounding information of the data it is processing. Examples of prompts, such as suggestion item prompts, are provided below.

As another example, the terms “prompt,” “user prompt,” or “system prompt” refer to a request made to a generative AI model to create a generative AI model output based on plain language guidance. A prompt commonly includes the user query, a real-time image, and multimodal embedding. For example, a prompt includes the user query, real-time input data (e.g., the real-time image and/or the real-time location data) received from the client device, and the multimodal embedding based on the user's current location.

A prompt can include instructions that direct a generative AI model to generate a response to the user query based on the real-time image and additional context included in the prompt. In various instances, a prompt provides rules and guidance for the generative AI on how the generative AI model should respond to a user query.

In some implementations, a prompt may provide information about what type of data is being provided to the generative AI model (e.g., either as part of the prompt or as a separate file). For example, the prompt indicates that a multimodal is being provided as a natural language narrative, an audio file, an image file, a feature vector, another data type, or a combination thereof.

In some instances, a prompt includes data management instructions. For example, if the provided data is a multimodal embedding represented as a feature vector, the prompt may instruct the generative AI model to directly embed the received multimodal embedding feature vector into the generative AI model's embedding space.

The term prompt can refer to a user prompt, a system prompt, or both. In various examples, a “user prompt” refers to a prompt that includes the user query and instructions to generate a response to the user query based on the real-time input data and data from a provided multimodal embedding. In some examples, a “system prompt” refers to a prompt that provides data management instructions for processing the provided multimodal embedding. For example, a system prompt indicates that the multimodal embedding is represented as a feature vector and instructs the generative AI model to directly inject the multimodal embedding feature vector into its embedding space and to use the multimodal embedding in the context of the models' embedding space to generate the user response. In some instances, the information described in connection with a system prompt can be included in a user prompt. Additionally, in some instances, a system prompt can include guidelines and guardrails relating to responsible AI practices and policies that the generative AI model should follow.

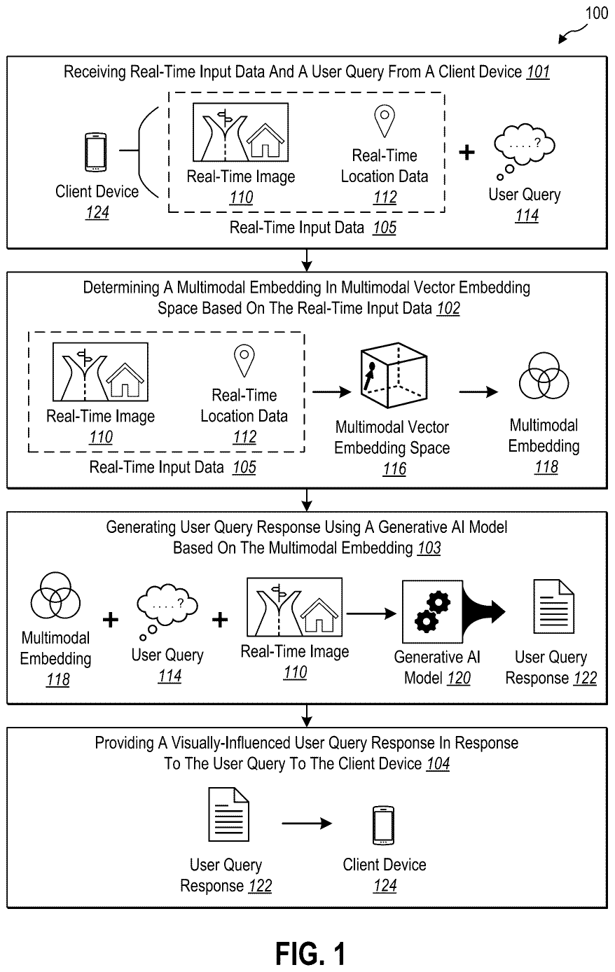

Additional example implementations and details of the location-based generation system are discussed in connection with the accompanying figures, which are described next. For example, FIG. 1 illustrates an example overview diagram of a location-based response system generating location-based responses based on multimodal embeddings using one or more generative AI models, according to some implementations. As shown, FIG. 1 illustrates a series of acts 100 performed (or caused to be performed) by the location-based response generation system.

As shown, the series of acts 100 includes act 101 of receiving a user query and real-time input data from a client device. For example, a user provides a location-based query regarding an image just captured by the client device. In particular, the location-based response system receives a user query 114 with real-time input data 105 from the client device 124, where the real-time input data includes a real-time image 110 and real-time location data 112 (e.g., the current location of the user's client device). For instance, the real-time image 110 may have been captured by the client device 124 to provide with the user query 114. In various implementations, the real-time image 110 may represent the scenery at a user's current location, as captured by the client device 124.

In various implementations, the user query 114 is an information or action request that corresponds to the real-time image provided with the user query. For instance, the user query 114 is a question relating to the current location of the user based on the real-time image 110. For example, the user query 114 is a question regarding a nearby business and/or store information at the user's current location (e.g., a picture of a store and the question “Does this store sell books?”). In another example, the user query 114 may be a query regarding navigation (e.g., “Where can I find the closest bookstore?”).

Act 102 includes determining a multimodal embedding in multimodal vector embedding space based on the real-time input data. In various implementations, the location-based response system generates a real-time embedding from the real-time image 110 and/or the real-time location data 112 using a multimodal embedding neural network model associated with the multimodal vector embedding space 116. The location-based response system identifies and locates a vector location in the multimodal vector embedding space 116 using the real-time embedding, such as a multimodal embedding 118 that is closest to the vector location.

Act 103 includes generating a user query response 122 using a generative AI model 120 based on the multimodal embedding 118. For example, the location-based response system generates and provides a prompt that includes the user query 114, the real-time image 110, and the multimodal embedding 118 to the generative AI model 120, with instructions to generate a user query response 122 based on the provided input, especially the multimodal embedding 118.

In some implementations, the location-based response system provides the multimodal embedding 118 to the generative AI model 120 as a natural language narrative, including multiple text descriptions corresponding to the multimodal inputs encoded in the multimodal embedding 118. In some implementations, the location-based response system provides the multimodal embedding 118 as a feature vector embedding, such that the generative AI model 120 uses the feature vector embedding to generate the user query response 122.

In various implementations, the generative AI model 120 utilizes visual features of the real-time image 110 along with references to visual features from the multimodal embedding 118 to generate a response to the user query. For example, the generative AI model 120 matches structures identified in the real-time image 110 with information about the structures included in the multimodal embedding 118 to generate a response to the user query influenced by the visual aspects of the structure.

The series of acts 100 further includes act 104 of providing a visually-influenced user query response to the client device in response to the user query. In various implementations, the location-based response system receives the user query response 122 from the generative AI model 120 and provides it to the client device 124. The location-based response system can facilitate follow-up user queries corresponding to the same real-time image as the previous user query or enable the client device 124 to provide additional user queries corresponding to additional real-time images.

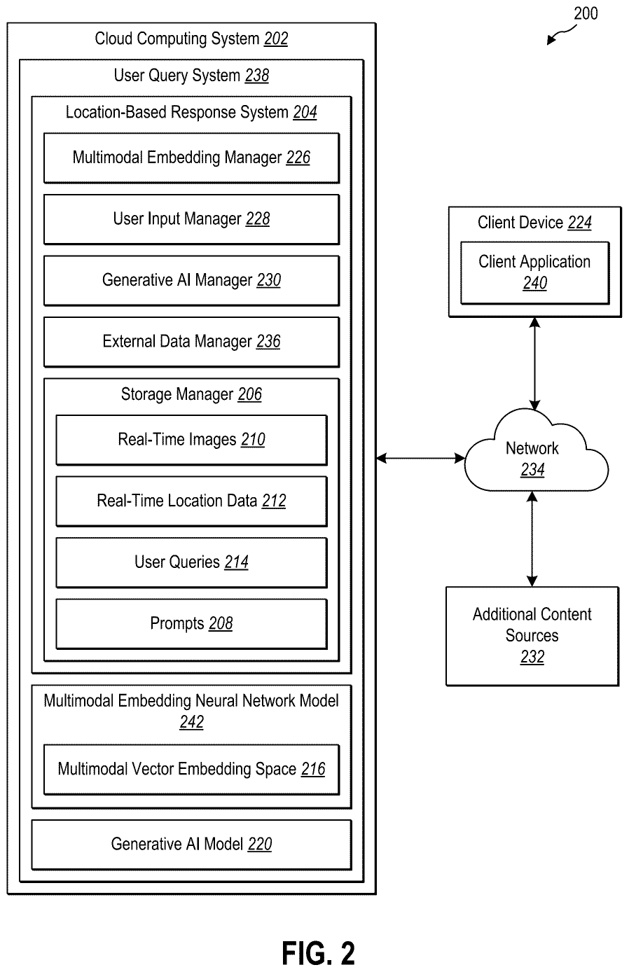

With a general overview in place, additional details are provided regarding the components, features, and elements of the location-based response system. To illustrate, FIG. 2 shows an example computing environment in which the location-based response system is implemented in a cloud computing system according to some implementations. In particular, FIG. 2 shows an example of a computing environment 200 with various computing devices within a cloud computing system 202 associated with a location-based response system 204. While FIG. 2 shows example arrangements and configurations of the computing environment 200, the cloud computing system 202, the location-based response system 204, and associated components, other arrangements and configurations are possible.

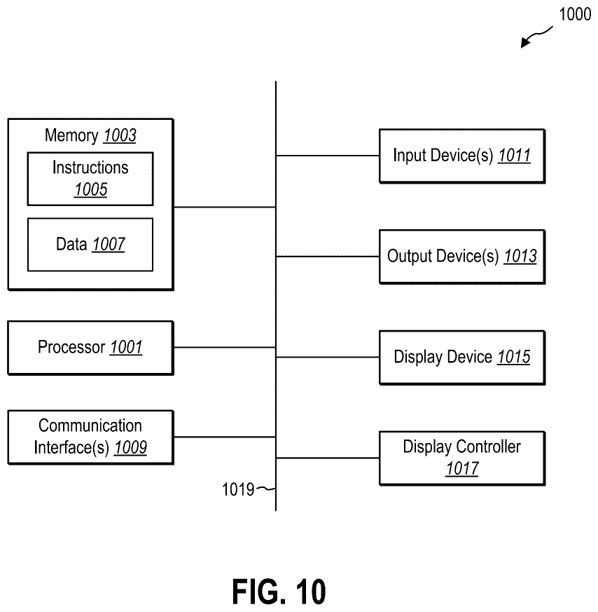

As shown, the computing environment 200 includes a cloud computing system 202, additional content sources 232, and a client device 224 with a client application 240, each connected to one other via the network 234. Many of these components may be implemented on one or more computing devices, such as one or more server devices. Some of these components may be implemented on personal devices. Further details regarding computing devices are provided below in connection with FIG. 10, along with additional details regarding networks, such as the network 234 shown.

The cloud computing system 202 includes a user query system 238. The user query system 238 includes a location-based response system 204, a multimodal embedding neural network model 242, and a generative AI model 220. The generative AI model 220 may include a computational system trained on one or more extensive datasets to produce coherent, contextually relevant, and fluent topic-specific outputs (e.g., text and/or images). With respect to location-based response systems, the generative AI model 220 can use natural language processing, feature vector embedding, machine learning, and image processing to generate coherent and contextually relevant human-like responses that have been visually influenced by a real-time image and location-based multimodal embeddings.

In various embodiments, the multimodal embedding neural network model 242 receives the different types of modality information or inputs for a target location (e.g., location data, image data, audio data, entity-based data, and/or text corresponding to a target location) and generates a multimodal embedding for the target location. In various implementations, the multimodal embedding neural network model 242 utilizes embedding techniques, which can include concatenation, attention mechanisms, or other fusion methods to create the multimodal embedding, which can then be stored in a multimodal vector embedding space 216. In some implementations, the multimodal embedding neural network model 242 is a neural network embedding encoder model. In some implementations, the multimodal embedding neural network model 242 is a generative AI encoder model.

The location-based response system 204 includes a multimodal embedding manager 226, a user input manager 228, a generative AI manager 230, an external data manager 236, and a storage manager 206. The storage manager 206 includes real-time images 210, real-time location data 212, user queries 214, and prompts 208. In some instances, the multimodal embedding neural network model 242 and/or the multimodal vector embedding space 216 is located within the location-based response system 204, or implemented by the location-based response system 204. As noted above, each of these components may be implemented on one or more computing devices, such as a set of one or more server devices.

The location-based response system 204 performs a variety of functions. In various implementations, the location-based response system 204 facilitates the generation of user query responses between the client device 224 and the generative AI model 220. As shown, the location-based response system 204 includes a user input manager 228, which interacts with the client application 240 of the client device 224 to receive a user query, a real-time location data, and a real-time image. The user input manager 228 also provides a user query response to the client device 224 in response to receiving it from the generative AI model 220 and the client application 240 displays the response in a graphical user interface of the client device 224.

Additionally, the location-based response system 204 includes a storage manager 206. In various implementations, the storage manager 206 stores the real-time images 210, the real-time location data 212, and user queries 214. In some implementations, the storage manager 206 also stores the prompts 208, which can include instructions.

Additionally, the location-based response system 204 includes a multimodal embedding manager 226, which interacts with the multimodal embedding neural network model 242 to generate the multimodal vector embedding space 216. For example, the multimodal embedding manager 226 may utilize the multimodal embedding neural network model 242 to generate a real-time embedding from the real-time image and the real-time location data. The multimodal embedding manager 226 can map the real-time embedding to the multimodal vector embedding space 216.

Furthermore, in various implementations, The multimodal embedding manager 226 can map the real-time embedding to the multimodal vector embedding space 216. to determine one or more multimodal embeddings co-located within the embedding space. For instance, the multimodal embedding manager 226 determines a multimodal embedding based on the vector location of the real-time embedding in the multimodal vector embedding space 216. In some instances, the multimodal embedding is determined based on being the shortest distance away (e.g., closest) from the vector location in the multimodal vector embedding space 216. In another example, multiple multimodal embeddings are identified within a threshold distance of the vector location in the multimodal vector embedding space 216.

As shown, the user query system 238 includes the generative AI model 220, which generates responses to prompts and other inputs. As described above, the generative AI model 220 may represent various types of generative AI models. In some implementations, the generative AI model 220 represents multiple instances of generative AI models. The generative AI manager 230 provides the multimodal embedding received from the multimodal vector embedding space 216 to the generative AI model 220 together with the real-time image and user query with instructions to generate a user query response to the user query based on the multimodal embedding.

In various implementations, the generative AI manager 230 generates a prompt, based on the user query, and provides the prompt with instructions together with the multimodal embedding, the real-time image, and the user query to the generative AI model 220. In some implementations, the instructions may include instructions for the generative AI model 220 to generate a user query response to the user query based on a multimodal embedding. For example, the prompt may include information regarding the content type (e.g., natural language narrative or multimodal feature vectors) provided to the generative AI model 220. In another example, the prompt may include information on what type of response (navigational response, location-related response, image identification response, etc.) the user is seeking. In some implementations, the prompt includes instructions and guidance on what the generative AI is allowed and/or not allowed to provide as a response to the user query.

In various implementations, the prompt includes the user query. In some implementations, the prompt provides information about what type of data is being provided to the generative AI model (e.g., either as part of the prompt or as a separate file). For example, the prompt indicates that a multimodal is being provided as a natural language narrative, an audio file, an image file, a feature vector, another data type, or a combination thereof.

In some implementations, the prompt includes the user query, the real-time image, and the multimodal embedding. In some implementations, the prompt includes the user query, the real-time image, and the natural language narrative (e.g., text) of the modalities included in the multimodal embedding.

In some instances, the generative AI manager 230 generates a prompt that includes data management instructions for handling the multimodal embedding provided in or with the prompt. For example, if the provided data is a multimodal embedding represented as a feature vector, the prompt may instruct the generative AI model to handle the multimodal embedding by directly embedding the received multimodal embedding feature vector into the generative AI model's embedding space.

In some instances, the generative AI manager 230 generates a user prompt, a system prompt, or both. In various examples, a user prompt includes the user query and instructions to generate a response to the user query based on the real-time input data and data from a provided multimodal embedding. In some examples, a system prompt includes data management and handling instructions for processing the provided multimodal embedding. For example, a system prompt indicates that the multimodal embedding is represented as a feature vector, and the prompt includes instructions for the generative AI model to directly inject the multimodal embedding feature vector into its embedding space and to use the multimodal embedding in the context of the models' embedding space to generate the user response. Additionally, in some instances, the system prompt can include guidelines and guardrails relating to responsible AI practices and policies that the generative AI model should follow when generating a user query response.

The generative AI model 220 uses the multimodal embedding, the prompt, the real-time image, and the user query to generate and return a user query response. In various implementations, the generative AI model 220 may generate the user query response by comparing visual features between the real-time image and visual features of the multimodal embedding. The location-based response system 204 may provide the user query response to the client device 224 in response to receiving the user query response from the generative AI model 220. The client application 240 may display the user query response in a display of the client device 224.

In various implementations, the location-based response system 204 may fetch additional location-specific information from additional content source 232 by using external data manager 236. In various implementations, the external data manager 236 may provide access to additional content sources 232 that can enhance the performance of the generative AI model 220 by providing additional modality data. For example, the additional content sources 232 may include images with seasonal variations, or time variations, from the current location.

In some implementations, when a multimodal embedding includes modalities with one or more images relating to a location, the one or more images may be all from the same year, time window, or season (e.g., spring, summer, fall, or winter). The additional content sources 232 may include images from different years, seasons, and/or times of day (day, night, etc.) to better help the generative AI model 220 to compare features of the real-time image with the one or more images included in the modalities of a multimodal embedding. In some implementations, the additional content sources 232 may include up-to-date information, such as fresher images from a location that may have changed after the multimodal embedding in the multimodal vector embedding space 216 was generated.

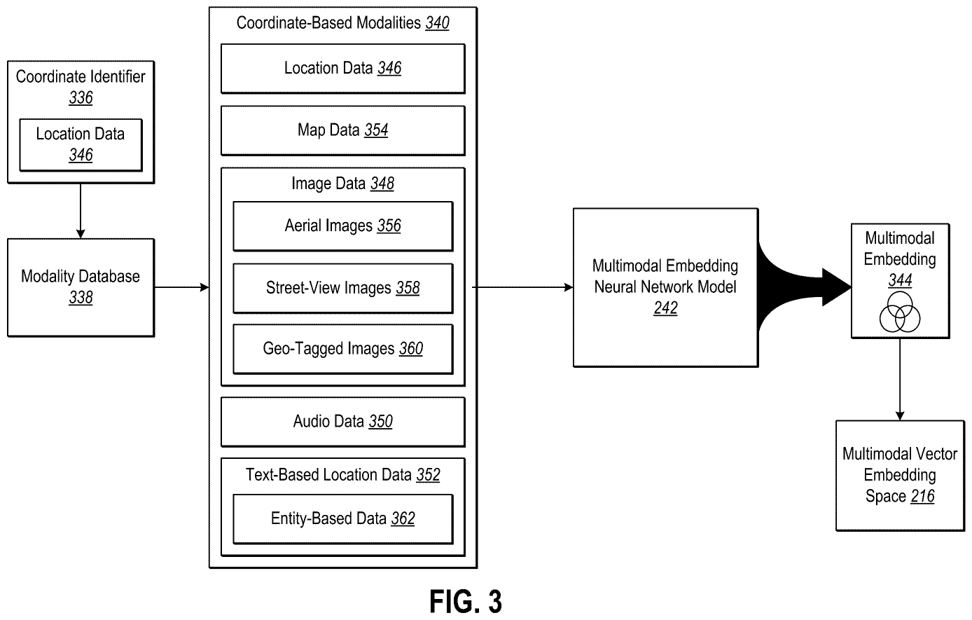

FIG. 3 illustrates an example diagram of generating a multimodal embedding in a multimodal vector embedding space according to some implementations. In particular, FIG. 3 shows an example of generating a multimodal vector embedding space 216. As shown, FIG. 3 includes a coordinate identifier 336, a modality database 338, coordinate-based modalities 340 (e.g., modality inputs), the multimodal embedding neural network model 242 (e.g., for transforming the coordinate-based modalities 340 into a multimodal embedding 344), and the multimodal vector embedding space 216.

In various implementations, the location-based response system 204 generates the multimodal vector embedding space 216 based on creating separate multimodal embeddings for different locations or coordinates within a geographical region. As provided in more detail below, the location-based response system 204 identifies a pinpoint location (e.g., a coordinate) within a region, gathers multimodal inputs for the location, generates a multimodal embedding for the location, and adds the multimodal embedding to the multimodal vector embedding space 216. The location-based response system 204 can repeat this process for some or all of the locations within the geographical area.

To elaborate, in some instances, the location-based response system 204 utilizes a coordinate identifier 336 to select a coordinate from a set of coordinates included in a region. For example, the location data 346 within the coordinate identifier 336 represents a selected location from a set of possible locations within a space, region, or geographical area. The location-based response system 204 then provides the selected coordinate (e.g., the location data 346) to the modality database 338.

In some implementations, the modality database 338 includes sets of location-based data for a target region or geographical area. For example, the modality database 338 includes a plurality of location data, a plurality of map data, a plurality of image data, a plurality of audio data, and a plurality of text-based location data. In some implementations, the modality database 338 stores data and metadata corresponding to multiple modalities (e.g., file formats and types) for each of the locations include in the database. In various implementations, each location is identified by a unique coordinate (e.g., a latitude and longitude pair, street address, geotag, or type of unique location identifier).

As shown, the coordinate-based modalities 340 represents the multimodal information obtained from the modality database 338 for the selected coordinate. In various implementations, the coordinate-based modalities 340 can include multimodal information for the selected coordinate from other data sources.

In some implementations, location-based response system 204 identifies multimodal information from the modality database 338 based on a distance threshold. For example, the location-based response system 204 selects map data, the image data, the audio data, and/or text-based location data that are marked with a location tag within 15 feet or 10 meters of the location data 346. The threshold distance may be between 0 meters and 10 meters or within a 100-meter or 1000-meter radius. For instance, in some implementations, the threshold distance depends on the density of the location (e.g., population density, traffic density, etc.). For example, in rural areas, the specified threshold may be larger than in urban areas.

The coordinate-based modalities 340 combines various modalities that relate to a specific coordinate location. In particular, the coordinate-based modalities 340 includes location data 346, such as location coordinates in one or more forms (e.g., degrees, minutes, and seconds (DMS), or detailed degrees (DD)). The location coordinates correspond to the map data 354, the image data 348, the audio data 350, and the text-based location data 352 fetched from the modality database 338. In other words, each of the modality inputs in the coordinate-based modalities 340 is based on, or captured at, the coordinates identified by the location data 346.

In some implementations, the coordinate-based modalities 340 include map data 354. In various implementations, the map data 354 includes a visual representation of an area, showing physical features, boundaries, roads, and/or other elements. In various implementations, the map data 354 includes topographic map information (e.g., providing information about elevation and terrain), symbolic map information, and/or physical map information (e.g., providing information about natural and manmade features).

In various embodiments, the coordinate-based modalities 340 include image data 348. As shown, the image data 348 includes geo-tagged images 360, aerial images 356, and/or street-view images 358. For example, the aerial images 356 may include a visual representation of an area captured from an elevated position. For example, by using satellites, aircraft, balloons, drones, or other airborne platforms. In various implementations, the aerial images 356 may be vertical aerial images taken directly above the area, providing a bird's eye view. In another implementation, aerial images 356 may be oblique aerial images captured at an angle, offering a more detailed perspective of an area.

In some implementations, the image data 348 includes street-view images 358. The street-view images 358 includes a visual representation of an area taken at street or ground level (e.g., human eye level). Street-view images 358 typically provides detailed images of the area surrounding a location coordinates. Street-view images 358 are typically captured by specialized cameras mounted on vehicles, such as cars or bikes, but can also be taken by pedestrians or drones.

In some implementations, the coordinate-based modalities 340 include geo-tagged images 360 associated with the location data 346. In various implementations, the image data 348 includes geo-tagged images 360. Geo-tagged images 360 can include photos that include geographical information about where they were captured. For example, geo-tagged images include images included in user reviews, entity websites, and photo data stores, for images that are associated with a specific location. In some implementations, location information for a geo-tagged image is embedded in the image file as metadata and can include information such as latitude, longitude, altitude, and name of the location. In some instances, the aerial images 356 and street-view images 358 can also be tagged with location-based metadata, such as where and when an image was captured.

In various implementations, the coordinate-based modalities 340 include audio data 350 associated with the location data 346. For instance, the audio data 350 includes audible files about the target location and/or sounds recorded at the location. For example, the audio data 350 may include nature sounds, such as moving water, wind in a forest, or bird sounds. In another example, the audio data 350 may include manmade sounds, such as church bells, traffic noises, construction noises, music, and speaking. In some implementations, the audio data 350 includes an audible description of features found in the location. For example, the audio data 350 may include a description of buildings and their features, a description of the nature and its features, etc.

In one or more implementations, the coordinate-based modalities 340 include text-based location data 352 associated with the location data 346. In various implementations, the text-based location data 352 includes information about the location in written form. In some implementations, the text-based location data 352 includes entity-based data 362. In some implementations, the entity-based data 362 refers to business-based data. In some implementations, entity-based data 362 includes information about a store, a business (e.g., business names, phone numbers, addresses, and their websites), or a landmark. For example, the entity-based data 362 may include information about opening hours, products, and/or services they provide, customer reviews, menus, price range, nearby parking, nearby public transit, phone, and address details, etc. The text-based location data 352 can also include additional text-based information about a location obtained for databases, tables, digests, websites, articles, and other resources.

As mentioned above, the location-based response system 204 generates a multimodal embedding for a target location or coordinate based on the coordinate-based modalities 340 associated with the target location. To illustrate, the location-based response system 204 provides the coordinate-based modalities 340 to the multimodal embedding neural network model 242.

In some implementations, the multimodal embedding neural network model 242 converts the different types of modalities into natural language text before tokenizing the text into a high-dimensional vector that represents the entire text from all modalities. This high-dimensional vector is then mapped into multimodal vector embedding space 216. Indeed, as shown, upon generating the multimodal embedding 344 from the coordinate-based modalities 340, the location-based response system 204 stores the multimodal embedding within the multimodal vector embedding space 216.

For each target location coordinate, the location-based response system 204 identifies coordinate-based modalities 340 from the modality database 338 (e.g., map data, image data, audio data, and/or text-based location data). Furthermore, for each coordinate-based modalities 340, the location-based response system 204 utilizes the multimodal embedding neural network model 242 to create a unique multimodal embedding, which gets stored in the multimodal vector embedding space 216. By doing so, the location-based response system 204 generates the multimodal vector embedding space 216 for an area, space, or region.

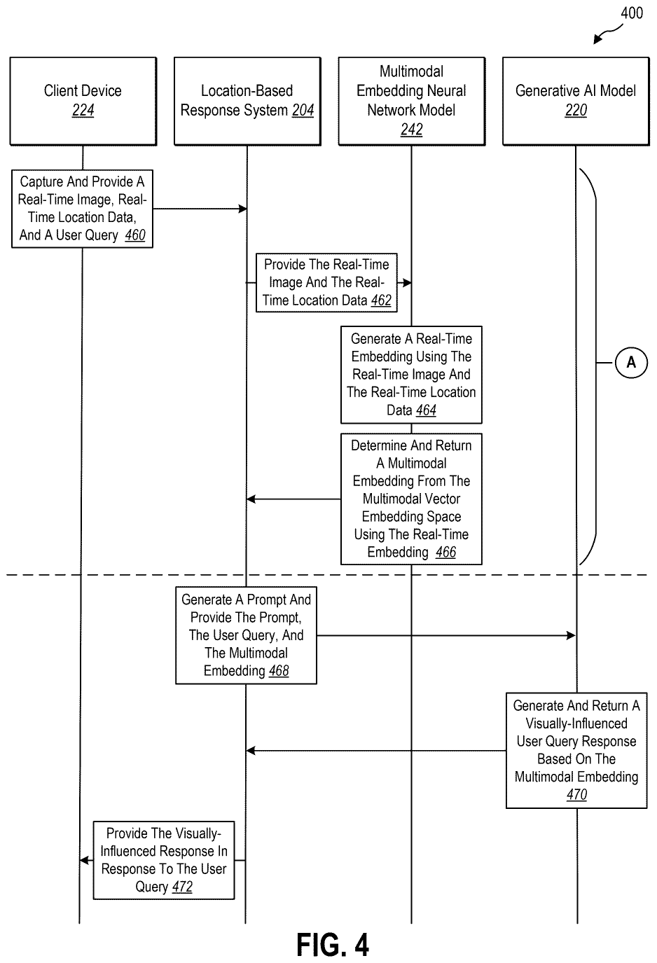

FIG. 4 illustrates an example sequence diagram for determining visually-influenced user query responses based on real-time user input of a location-based multimodal embedding and a generative AI model according to some implementations. In particular, FIG. 4 includes a series of acts 400 performed by, or under the direction of, the location-based response system 204 in connection with the client device 224, the multimodal embedding neural network model 242, and the generative AI model 220, which were introduced above.

As shown, the series of acts 400 begins with act 460 of capturing and providing a real-time image, real-time location data, and a user query from the client device 224 to the location-based response system 204. For example, the client device 224 provides a user query to the location-based response system 204, which includes a real-time, and real-time location data. In various implementations, the user query is a question about the location or environment captured within the real-time image.

In various implementations, the user query may be captured as text, audio, or another input format. For example, the user may type in the query, the client device 224 may record the query as audio or video, or the client device 224 may use voice-to-text functionality to convert an audible query into a text form.

As mentioned, the user query is commonly associated with a real-time image. For example, in connection with providing the user query, the location-based response system 204 (or a client application on the client device 224 associated with the location-based response system 204) causes the client device 224 to capture a real-time image with a camera of the client device 224. The real-time image may include structures, street signs, roads, business and store logos and signs, vehicles, people, landmarks, natural formations, such as a river, forest, cave, etc., or a combination of elements. In various implementations, the real-time image may be a still image, a live image, or a video. In some implementations, the real-time image represents a field-of-view (FoV) of what the user of the client device sees. In some implementations, the real-time image includes various objects (e.g., a street-level image), and the location-based response system 204 performs a sub-image analysis to identify the locations of objects in the image and the relationships among those objects.

In various implementations, the real-time location data is automatically provided together with the real-time image as metadata (e.g., geo-tagged image). For example, the real-time image may include the location of where the image was taken as descriptive metadata as part of a real-time image file. In some implementations, the real-time location data is provided by a Global Positioning System (GPS) receiver in the client device. In some instances, the real-time location data may be provided in a degrees, minutes, and seconds (DMS) format, such as N 47° 36′ 22.3524″, W 122° 19′55.4556″ for Seattle, WA. In another example, the real-time location data may be provided in decimal degrees (DD) format, such as N 47.6062°, W −122.3321° for Seattle, WA. In various implementations, the real-time location data may be assisted GPS (A-GPS) data. A-GPS uses additional data from cell towers and Wi-Fi networks to help the GPS receiver get a faster and more accurate fix on the location.

In act 462, the location-based response system 204 provides the real-time image and the real-time location data to the multimodal embedding neural network model 242. In some implementations, multimodal embedding neural network model 242 includes the multimodal vector embedding space 216 described above, which was created to include multimodal embeddings corresponding to some or all of the locations within an area generated from multimodal data corresponding to each of the locations.

In act 464, the multimodal embedding neural network model 242 (or the location-based response system 204 using the multimodal embedding neural network model 242) determines and returns a real-time embedding using the real-time image and the real-time location data. In various implementations, the multimodal embedding neural network model 242 generates a vector location corresponding to the real-time embedding in the multimodal vector embedding space 216.

In act 466, the multimodal embedding neural network model 242 (or the location-based response system 204 using the multimodal embedding neural network model 242) determines a multimodal embedding from the multimodal vector embedding space 216 using the real-time embedding. For example, a multimodal embedding from the multimodal vector embedding space 216 is determined based on proximity to the real-time embedding and/or its vector location. In various implementations, the multimodal embedding neural network model 242 or the location-based response system 204 identifies or determines the multimodal embedding that is closest to the vector location and/or within a threshold distance of the vector location.

In some implementations, multiple multimodal embeddings are located within a threshold distance of the vector location. In these cases, the closest multimodal embedding or all multimodal embeddings within the threshold distance can be determined. Upon determining a multimodal embedding (or multiple multimodal embeddings), the multimodal embedding (or embeddings) is provided to the location-based response system 204.

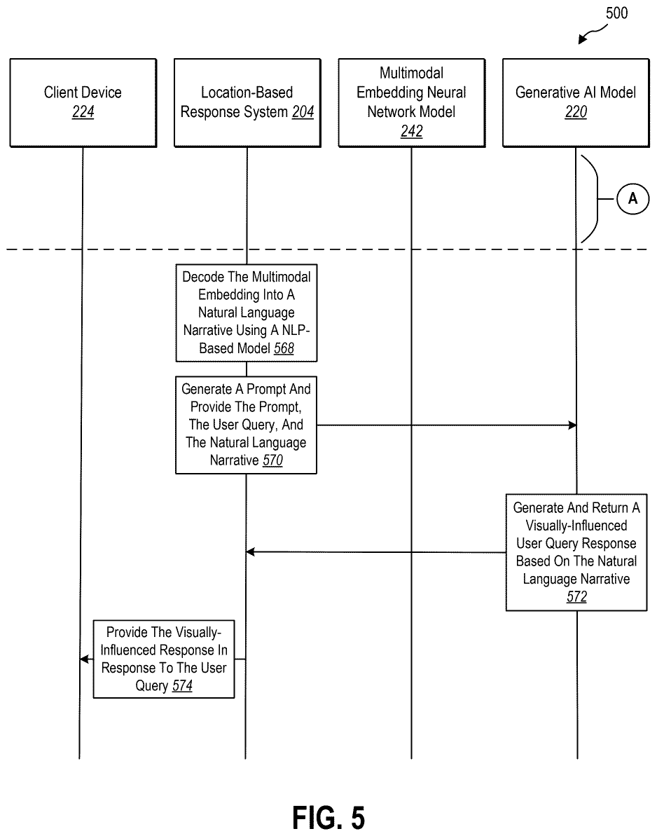

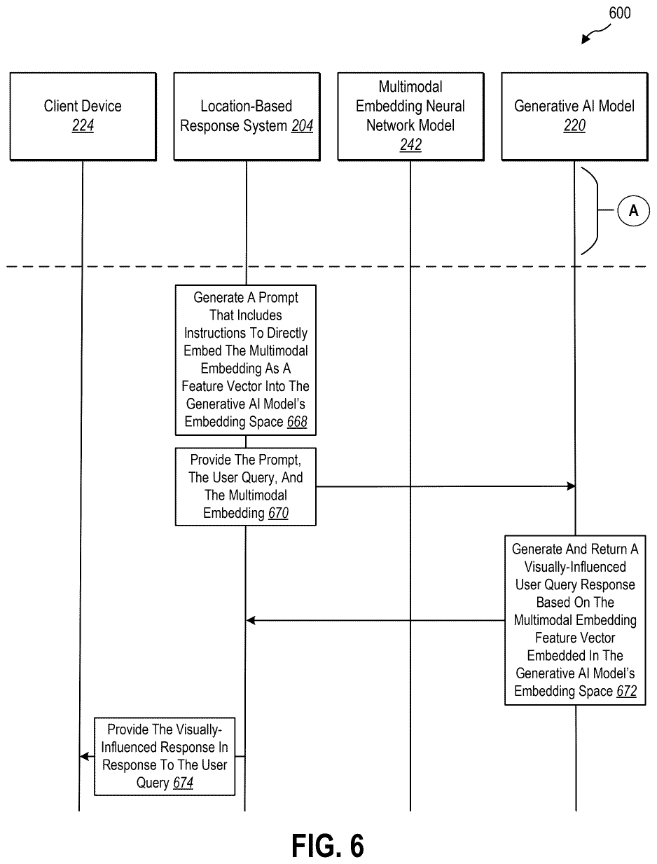

As shown, act 460 through act 466 are associated with Sequence A. Sequence A will be referred to in FIG. 5 and FIG. 6, without repeating the details of act 460 through act 466.

In act 468, the location-based response system 204 generates a prompt and provides the prompt, the user query, and the multimodal embedding to the generative AI model 220. The prompt may be a user prompt (e.g., a user query prompt), a system prompt, or both. In various embodiments, the user query is included as part of the prompt. In various implementations, the location-based response system 204 generates a prompt based on the user query. In some embodiments, the multimodal embedding is included as part of the user prompt. In various embodiments, a system prompt may include data handling instructions to the generative AI model 220 for handling the multimodal embedding based on whether it is provided as a natural language narrative or a multimodal feature vector.

As mentioned, in some instances, the location-based response system 204 provides the real-time image with the prompt to the generative AI model 220. In some instances, the location-based response system 204 pre-processes the real-time image, such as extracting visual features of the real-time images. The location-based response system 204 can provide the visual features of the real-time image with the user query to the generative AI model 220. In some implementations, the location-based response system 204 generates a natural language narrative of the visual features of the real-time image, and provides the natural language narrative of the real-time image along with the user prompt.

Act 470 includes the generative AI model 220 generating and returning a visually-influenced user query response for the user query based on the multimodal embedding. For example, the generative AI model 220 utilizes its broad training to analyze the user query from the prompt. Additionally, based on the instructions in the prompt, the generative AI model 220 concentrates on the location-based information, including visual information, from the multimodal embedding to generate a response to the user query. In various implementations, the generative AI model 220 also concentrates on the real-time image, including comparing visual features of the real-time image to visual features included in the multimodal embedding. In these implementations, the generative AI model 220 generates a user response that provides visual guidance that confirms or corrects the user query.

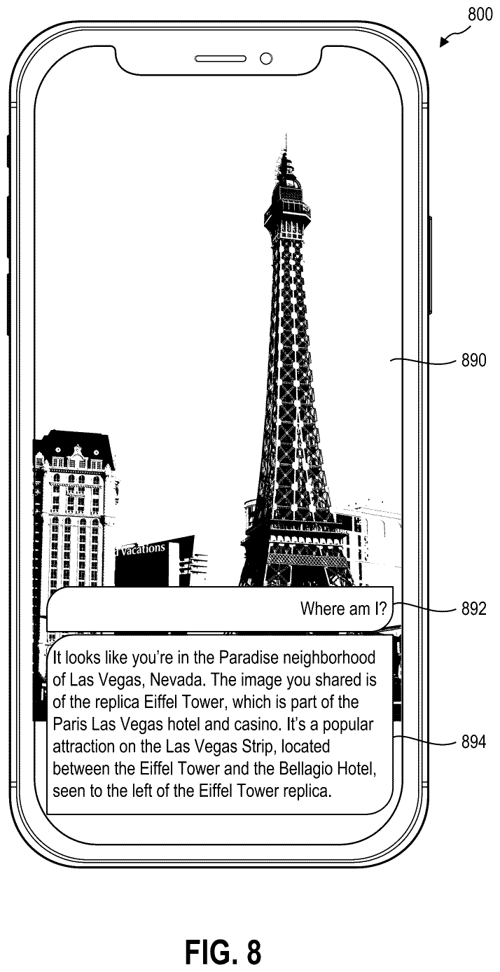

Act 472 shows that, in response to receiving the user query response from the generative AI model 220, the location-based response system 204 provides the visually influenced user query response in response to the user query. In various implementations, the location-based response system 204 provides the user query response within a graphical user interface that includes the real-time image (or a copy of it). An example of a user risk score is provided in connection with FIG. 8

FIG. 5 illustrates an example sequence diagram for determining visually-influenced user query responses based on natural language narratives of a location-based multimodal embedding and a generative AI model according to some implementations. In particular, FIG. 5 includes a series of acts 500 performed by, or under the direction of, the location-based response system 204 in connection with the client device 224, the multimodal embedding neural network model 242, and the generative AI model 220.

As shown, the series of acts 500 begins with Sequence A, which includes act 460 through act 466 from FIG. 4, as described above. For example, the series of acts 500 begins with getting a real-time image and user from the client device 224, generating a real-time embedding from the real-time user information, and determining a multimodal embedding in the multimodal vector embedding space based on the real-time embedding.

The series of acts 500 continues with act 568 of decoding the multimodal embedding into a natural language narrative using a natural language processing-(NLP) based model. For example, each modality included in the multimodal embedding is described in natural language. In some implementations, the location-based response system 204 provides the multimodal embedding to an NLP-based model that decodes the feature vectors of embedding and creates a text narrative of the decoded feature vectors. In various implementations, natural language narrative include a text description of the feature vectors belonging to each multimodal input used to generate the embedding. In some implementations, the natural language narrative is an aggregated text summary of the multimodal embedding as a whole.

Act 570 shows generating a prompt and providing the prompt, the user query, and the natural language narrative to the generative AI model 220. The prompt may be a user prompt, a system prompt, or both. The natural language narrative can be included in the prompt along with the user query or it can be provided separately. In various embodiments, the prompt (e.g., a user prompt or a system prompt) may include instructions indicating that the multimodal embedding is provided as a natural language narrative to the generative AI model 220. In some instances, the location-based response system 204 provides both the natural language narrative and the multimodal embedding to the generative AI model 220.

Act 572 includes the generative AI model 220 generating and returning a visually-influenced user query response for the user query based on the natural language narrative. In various implementations, the generative AI model 220 ingests the user query and the natural language narrative, which provides additional context to the user query. Based on the additional context, the generative AI model 220 generates a user query response. As mentioned above, the generative AI model 220 may also use the real-time image (e.g., use the image directly or a pre-processed version of the real-time image) to generate a response to the user query. In some instances, the generative AI model 220 may compare visual features of the real-time image to visual features described by the natural language narrative of the multimodal embedding.

Act 574 includes the location-based response system 204 providing the visually-influenced user query response in response to the user query. For example, in response to receiving the visually-influenced user query response from the generative AI model 220, the location-based response system 204 provides it to the client device 224. As mentioned, the location-based response system 204 may display the user query response within a graphical user interface and/or application on the client device 224.

FIG. 6 illustrates an example sequence diagram for determining visually-influenced user query responses based on directly embedding a location-based multimodal embedding into a generative AI model according to some implementations. In particular, FIG. 6 includes a series of acts 600 performed by, or under the direction of, the location-based response system 204 in connection with the client device 224, the multimodal vector embedding space 216, and the generative AI model 220.

As shown, the series of acts 600 begins with Sequence A, which includes act 460 through act 466 from FIG. 4, as described above. For example, the series of acts 600 begins with getting a real-time image and user from the client device 224, generating a real-time embedding from the real-time user information, and determining a multimodal embedding in the multimodal vector embedding space based on the real-time embedding.

The series of acts 500 continues with act 668 of generating a prompt that includes instructions to directly embed the multimodal embedding as a feature vector into the generative AI model's embedding space. In various implementations, the location-based response system 204 provides the multimodal embedding as a feature vector (as part of the prompt or alongside the prompt) to the generative AI model 220 to directly process. Accordingly, in these instances, the location-based response system 204 generates a prompt that includes the user query and data handling instructions for the multimodal embedding. For instance, the instructions direct the generative AI model 220 to embed or inject the feature vector into its embedding space, for use during the decoding process in generating the user query response. By doing so, the generative AI model 220 may directly access the multimodal embedding and its modalities from its own embedding space.

In various implementations, the generative AI model 220 is associated with the multimodal embedding neural network model 242. For example, the generative AI model 220 utilizes the same or similar multimodal embedding encoding functions to generate multimodal embeddings. In these instances, the multimodal embedding provided to the generative AI model 220 will be compatible and seamlessly integrated into the model's embedding space. If the embedding has a different parameter, the location-based response system 204 and/or the generative AI model 220 can covert the multimodal embedding to be compatible with the model's embedding space.

Act 670 includes providing the prompt, the user query, and the multimodal embedding from the location-based response system 204 to the generative AI model 220. As mentioned, the multimodal embedding is provided as a feature vector and may be provided with the prompt or as a separate input. Similarly, the real-time image may be provided within the prompt or alongside the prompt as a separate input.

Act 672 includes generating and returning a visually-influenced user query response based on the multimodal embedding feature vector embedded in the generative AI model's embedding space. For example, the generative AI model 220 processes the user query to generate a response. However, based on the instructions in the prompt, the generative AI model 220 can directly access the encoded features from the injected multimodal embedding to understand the location-based context of the user query and the real-time image, to more accurately and efficiently generate a visually-influenced user query response.

As mentioned, act 672 includes returning the visually-influenced user query response to the location-based response system 204. Additionally, the location-based response system 204 can provide the visually-influenced user query response to the client device 224, as shown in act 674, and as described above.

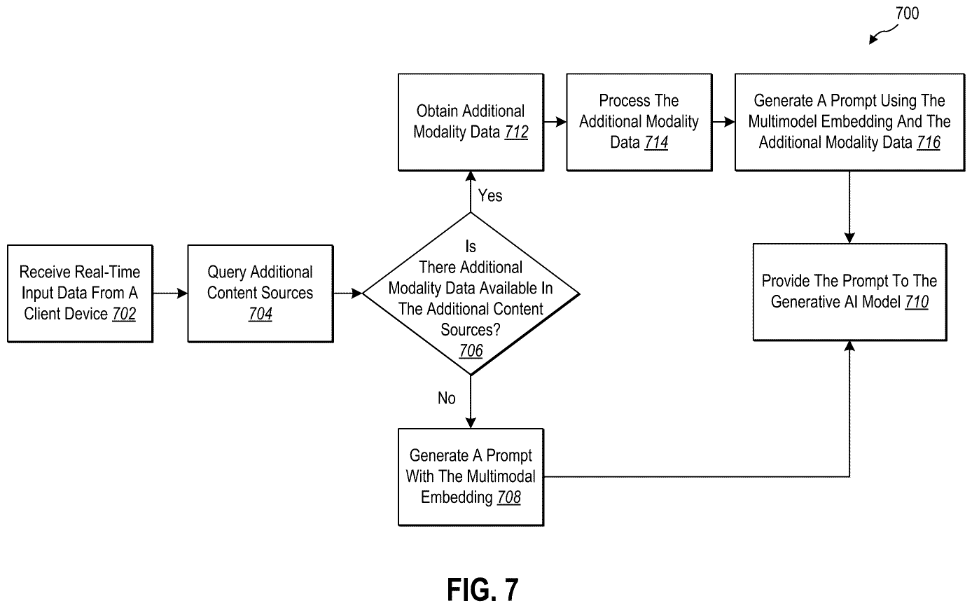

FIG. 7 illustrates an example state diagram for identifying external location-based information used to generate a visually-influenced response to a user query according to some implementations. As shown, FIG. 7 includes a series of acts 700 performed by the location-based response system to facilitate the generation of location-based user query responses in response to the user query.

As mentioned earlier, the location-based response system may access additional content sources to enhance the performance of the generative AI model by providing additional modality data. For example, the additional content sources may include images from the current location with seasonal or time variations. Providing different images can assist the generative AI model to better compare features of the real-time image with both images including a multimodal embedding and additionally provided images.

In addition to images, the location-based response system 204 can provide other modality input, such as content recently posted online about a target location, which has not yet been included in a multimodal embedding for the target location. In this way, the additional content sources may include up-to-date information, such as fresh or fresher content from a target location, which may have changed after the multimodal embedding in the multimodal vector embedding space was generated.

To address this issue, the location-based response system 204 may supplement the prompt with content from additional content sources. To illustrate, FIG. 7 includes the series of acts 700, which begins with act 702 of receiving real-time input data from a client device. For example, the real-time input data may include a user query, a real-time image, and real-time location data.

Act 704 includes querying additional content sources. In some implementations, the location-based response system 204 may always query additional modality data from additional content sources. In some embodiments, the location-based response system 204 may determine whether or not to query the additional content sources, as further discussed below.

Act 706 includes determining whether there is additional modality data available in the additional content sources. In some embodiments, the creation date of the determined multimodal embedding is used as a threshold date, and the location-based response system 204 determines whether the additional content was created before the creation date (or within a threshold period of the creation date). If the additional content is not fresher than the multimodal embedding, the location-based response system 204 performs act 708 of generating a prompt with the multimodal embedding, as described above. Furthermore, as shown in act 710, the location-based response system 204 can provide the prompt to the generative AI model (along with the multimodal embedding and real-time image) to generate a visually-influenced user query response.

If the additional content is fresher than the multimodal embedding, the location-based response system 204 performs act 712 of obtaining additional modality data from additional content sources 232 when it is determined that there is additional modality data available. In some implementations, the additional content includes a multimodal input that is included in creating the multimodal embedding. In some instances, the location-based response system 204 can proceed with act 712.

Act 714 includes the location-based response system 204 processing the additional modality data. For example, the location-based response system 204 decodes the additional modality data into a natural language narrative using an NLP-based model, as described above. Act 716 includes the location-based response system 204 generating a prompt using the multimodal embedding and the additional modality data. Indeed, the location-based response system 204 includes the additional location-based information for the target location and/or corresponding context in the prompt. In some implementations, the location-based response system 204 provides this data using retrieval-augmented generation (RAG) techniques.

As shown, the location-based response system 204 may also perform act 710 of providing the prompt to the generative AI model. In particular, the location-based response system 204 provides the response, enhanced with the additional, fresher context to the generative AI model.

FIG. 8 illustrates an example graphical user interface of providing a visually-influenced response to a user query according to some implementations. In particular, FIG. 8 illustrates a client application 800 displaying a graphical user interface (GUI). The client application 800 may be part of a generative AI model-based chat application or a navigational application.

As shown, the client application 800 includes a real-time image 890, a user query 892, and a user query response 894. As previously discussed, the client device may capture the real-time image 890 in connection with providing the user query 892. In various instances, the client application 800 sends the real-time image 890, real-time location data, and the user query 892 to the location-based response system 204.

In response, the location-based response system 204 may provide a visually-influenced location-based user query response. As illustrated, the client device has captured an image of a building that looks like the Eiffel Tower. In traditional systems, a generative AI model may mistakenly determine that the image is of the Eiffel Tower in Paris, France. However, as previously discussed, the location-based response system 204 is able to fetch a multimodal embedding, based on the received user input data and instruct the generative AI model to generate a response to the user query based on the multimodal embedding at the target location.

The generative AI model can also use visual features of the real-time image 890, influenced by a corresponding location-based multimodal embedding, to determine that the image is of the replica Eiffel Tower in Las Vegas, determine what the building in the background, and what visual environment the user sees beyond the real-time image 890. For example, the visually-influenced response includes information about the building seen in the real-time image, and additional location-based information, such as the Las Vegas Strip (not visible in the real-time image), and the Bellagio Hotel (shown only partially in the real-time image).

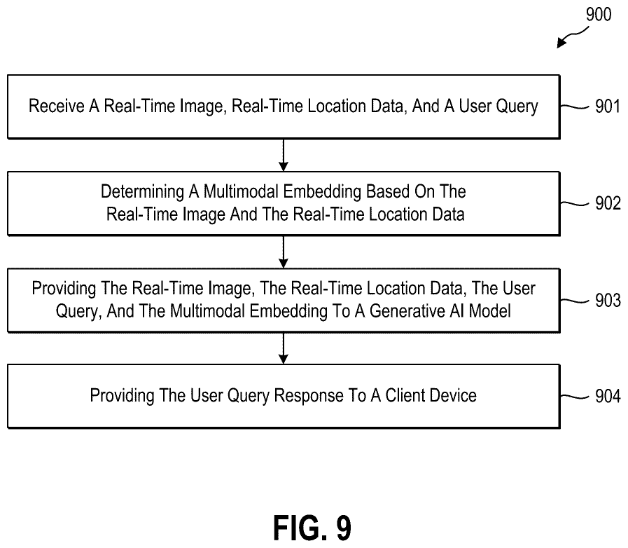

FIG. 9 illustrates an example series of acts in a computer-implemented method for generating location-based responses based on multimodal embeddings and generative AI models, according to some implementations. While FIG. 9 illustrates acts according to one or more implementations, alternative implementations may omit, add to, reorder, and/or modify any of the acts shown. Furthermore, the acts of FIG. 9 can each be performed as part of a method (e.g., a computer-implemented method). Alternatively, a computer-readable medium can include instructions that, when executed by a processing system having a processor, cause a computing device to perform each of the acts of FIG. 9. In some implementations, a system (e.g., a processing system having a processor and a computer memory including instructions that, when executed by the processing system, cause the system to perform various actions or steps) can perform each of the acts of FIG. 9.

As shown in FIG. 9, the series of acts 900 includes act 901 of receiving a real-time image, real-time location data, and a user query. For example, the real-time image, the real-time location data, and the user query may be received from a client device. In various embodiments, a real-time embedding is generated from the real-time image and the real-time location data using a multimodal embedding neural network model associated with the multimodal vector embedding space. In some instances, the real-time embedding has a vector location in the multimodal vector embedding space.

As further shown in FIG. 9, the series of acts 900 includes act 902 of determining a multimodal embedding based on the real-time image and the real-time location data. In various embodiments, the multimodal embedding is determined based on the vector location of the real-time embedding. For example, the multimodal embedding may the closest to the vector location. In another example, multiple multimodal embeddings are identified within a threshold distance from the vector location of the real-time embedding, the multiple multimodal embeddings including the multimodal embedding.

As further shown in FIG. 9, the series of acts 900 includes act 903 of providing the real-time image, the real-time location data, the user query, and the multimodal embedding to a generative AI model. In various embodiments, the generative AI generates a user query response for the user query based on the multimodal embedding.

As further shown in FIG. 9, the series of acts 900 includes act 904 of providing the user query response to a client device. In some implementations, the user query response is provided to the client device upon receiving the user query response from the generative AI model.

In some aspects, the techniques described herein relate to a computer-implemented method for generating location-based responses from multimodal embeddings using one or more generative artificial intelligence (AI) models, the computer-implemented method including: receiving a real-time image, real-time location data, and a user query from a client device; determining a multimodal embedding in a multimodal vector embedding space based on the real-time image and the real-time location data; providing the real-time image, the real-time location data, the user query, and the multimodal embedding to a generative AI model with instructions to generate a user query response to the user query based on the multimodal embedding; and providing the user query response to the client device in response to receiving the user query response from the generative AI model.

In some aspects, the techniques described herein relate to a computer-implemented method, further including: generating a real-time embedding from the real-time image and the real-time location data using a multimodal embedding neural network model associated with the multimodal vector embedding space; and identifying a vector location in the multimodal vector embedding space using the real-time embedding to identify.

In some aspects, the techniques described herein relate to a computer-implemented method, further including determining the multimodal embedding based on the vector location.

In some aspects, the techniques described herein relate to a computer-implemented method, wherein the multimodal embedding is determined to be closest to the vector location.

In some aspects, the techniques described herein relate to a computer-implemented method, wherein determining the multimodal embedding in the multimodal vector embedding space further includes: identifying multiple multimodal embeddings within a threshold distance of the vector location, wherein the multiple multimodal embeddings include the multimodal embedding; and providing the multiple multimodal embeddings to the generative AI model along with a user query prompt that includes the instructions to generate the user query response.

In some aspects, the techniques described herein relate to a computer-implemented method, wherein the user query prompt includes instructions to compare visual features between the real-time image and visual features of the multimodal embedding to generate the user query response.

In some aspects, the techniques described herein relate to a computer-implemented method, wherein providing the user query response to the client device further includes providing two or more of a text response, map directions, or map information within a graphical user interface of the client device.

In some aspects, the techniques described herein relate to a computer-implemented method, wherein determining the multimodal embedding in the multimodal vector embedding space further includes determining the multimodal embedding as the closest multimodal embedding to the vector location in the multimodal vector embedding space.

In some aspects, the techniques described herein relate to a computer-implemented method, further including: pre-processing the real-time image to extract visual features of the real-time image; and providing the visual features of the real-time image with the user query to the generative AI model.

In some aspects, the techniques described herein relate to a computer-implemented method, further including: for a location, providing two or more multimodal inputs to a multimodal embedding neural network model, wherein the two or more multimodal inputs include one or more images of the location, text information of the location, business information of the location, and maps information of the location as multimodal input; and generating the multimodal embedding of the location using the multimodal embedding neural network model from the multimodal input.

In some aspects, the techniques described herein relate to a computer-implemented method, wherein the one or more images of the location include one or more aerial images of the location or street-view images of the location.

In some aspects, the techniques described herein relate to a computer-implemented method, wherein providing the multimodal embedding to the generative AI model further includes: decoding the multimodal embedding into a natural language narrative, wherein the natural language narrative includes multiple descriptions corresponding to each of the two or more multimodal inputs used to create the multimodal embedding; and providing the natural language narrative of the multimodal embedding to the generative AI model along with the user query.

In some aspects, the techniques described herein relate to a computer-implemented method, wherein providing the multimodal embedding to the generative AI model further includes providing the multimodal embedding to the generative AI model embedding a feature vector embedding such that the generative AI model uses the feature vector embedding to generate the user query response.

In some aspects, the techniques described herein relate to a computer-implemented method, further including providing a system prompt to the generative AI model with the real-time image, the real-time location data, the multimodal embedding, and a user query prompt that includes the user query and the instructions; wherein the system prompt provides additional data handling instructions.

In some aspects, the techniques described herein relate to a computer-implemented method, further including: determining from an external database that fresher location information is available for a location identified in the real-time location data; requesting the fresher location information from the external database; and providing the fresher location information to the generative AI model.

In some aspects, the techniques described herein relate to a computer-implemented method for generating location-based responses from multimodal embeddings using one or more generative artificial intelligence (AI) models, including: receiving a real-time image, real-time location data, and a user query from a client device; identifying a multimodal embedding in multimodal vector embedding space by using the real-time image and location data; providing the real-time image, the real-time location data, the user query, and the multimodal embedding to a generative AI model with instructions to generate a user query response based on the multimodal embedding, wherein providing the multimodal embedding to the generative AI model further includes providing the multimodal embedding to the generative AI model embedding a feature vector embedding such that the generative AI model uses the feature vector embedding to generate the user query response; and providing the user query response to the client device in response to receiving the user query response from the generative AI model.

In some aspects, the techniques described herein relate to a computer-implemented method, further including: generating a real-time embedding from the real-time image and the real-time location data using a multimodal embedding neural network model associated with the multimodal vector embedding space; and identifying a vector location in the multimodal vector embedding space using the real-time embedding to identify.

In some aspects, the techniques described herein relate to a computer-implemented method, further including determining the multimodal embedding based on the vector location.

In some aspects, the techniques described herein relate to a computer-implemented method, further including providing to the generative AI model a user query prompt that includes the instructions to generate the user query response, wherein the user query prompt includes instructions to compare visual features between the real-time image and visual features of the multimodal embedding to generate the user query response.

In some aspects, the techniques described herein relate to a system for generating location-based responses from multimodal embeddings using one or more generative artificial intelligence (AI) models, the system including: multimodal vector embedding space that includes a multimodal embedding generated by a multimodal embedding neural network model from two or more multimodal inputs; generative AI model; a processing system having a processor; and a computer memory including instructions that, when executed by the processing system, cause the system to carry out operations including: receiving a real-time image, real-time location data, and a user query from a client device; determining the multimodal embedding in the multimodal vector embedding space based on the real-time image and the real-time location data, wherein providing the multimodal embedding to the generative AI model further includes: decoding the multimodal embedding into a natural language narrative, wherein the natural language narrative includes multiple descriptions corresponding to each of the two or more multimodal inputs used to create the multimodal embedding; providing the real-time image, the real-time location data, the user query, and the natural language narrative of the multimodal embedding to the generative AI model with instructions to generate a user query response to the user query based on the multimodal embedding; and providing the user query response to the client device in response to receiving the user query response from the generative AI model.

FIG. 10 illustrates certain components that may be included within a computer system 1000. The computer system 1000 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 1000 represents one or more of the client devices, server devices, or other computing devices described above. For example, the computer system 1000 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 1000 includes a processing system including a processor 1001. The processor 1001 may be a general-purpose single-or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 1001 may be referred to as a central processing unit (CPU) and may cause computer-implemented instructions to be performed. Although the processor 1001 shown is just a single processor in the computer system 1000 of FIG. 10, in an alternative configuration, a combination of processors (e.g., an ARM and DSP) could be used.

The computer system 1000 also includes memory 1003 in electronic communication with the processor 1001. The memory 1003 may be any electronic component capable of storing electronic information. For example, the memory 1003 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 1005 and the data 1007 may be stored in the memory 1003. The instructions 1005 may be executable by the processor 1001 to implement some or all of the functionality disclosed herein. Executing the instructions 1005 may involve the use of the data 1007 that is stored in the memory 1003. Any of the various examples of modules and components described herein may be implemented, partially or wholly, as instructions 1005 stored in memory 1003 and executed by the processor 1001. Any of the various examples of data described herein may be among the data 1007 that is stored in memory 1003 and used during the execution of the instructions 1005 by the processor 1001.

A computer system 1000 may also include one or more communication interface(s) 1009 for communicating with other electronic devices. The one or more communication interface(s) 1009 may be based on wired communication technology, wireless communication technology, or both. Some examples of the one or more communication interface(s) 1009 include a Universal Serial Bus (USB), an Ethernet adapter, a wireless adapter that operates according to an Institute of Electrical and Electronics Engineers (IEEE) 1002.11 wireless communication protocol, a Bluetooth® wireless communication adapter, and an infrared (IR) communication port.

A computer system 1000 may also include one or more input device(s) 1011 and one or more output device(s) 1013. Some examples of the one or more input device(s) 1011 include a keyboard, mouse, microphone, remote control device, button, joystick, trackball, touchpad, and light pen. Some examples of the one or more output device(s) 1013 include a speaker and a printer. A specific type of output device that is typically included in a computer system 1000 is a display device 1015. The display device 1015 used with implementations disclosed herein may utilize any suitable image projection technology, such as liquid crystal display (LCD), light-emitting diode (LED), gas plasma, electroluminescence, or the like. A display controller 1017 may also be provided for converting data 1007 stored in the memory 1003 into text, graphics, and/or moving images (as appropriate) shown on the display device 1015.

The various components of the computer system 1000 may be coupled together by one or more buses, which may include a power bus, a control signal bus, a status signal bus, a data bus, etc. For clarity, the various buses are illustrated in FIG. 10 as a bus system 1019.

This disclosure describes a subjective data application system in the framework of a network. In this disclosure, a “network” refers to one or more data links that enable electronic data transport between computer systems, modules, and other electronic devices. A network may include public networks such as the Internet as well as private networks. When information is transferred or provided over a network or another communication connection (either hardwired, wireless, or both), the computer correctly views the connection as a transmission medium. Transmission media can include a network and/or data links that carry required program code in the form of computer-executable instructions or data structures, which can be accessed by a general-purpose or special-purpose computer. Combinations of the above are also included within the scope of computer-readable media.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the various systems described in this disclosure. Indeed, the networks described herein may include one or multiple networks that use one or more communication platforms or technologies for transmitting data. For example, a network may include the Internet or other data link that enables transporting electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC), and then it is eventually transferred to computer system RAM and/or to less volatile computer storage media (devices) at a computer system. Thus, it should be understood that computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Rather, the described features and acts are disclosed as example forms of implementing the claims.

Those skilled in the art will appreciate that the disclosure may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

1. A computer-implemented method for generating location-based responses from multimodal embeddings using one or more generative artificial intelligence (AI) models, the computer-implemented method comprising:
receiving a real-time image, real-time location data, and a user query from a client device;
determining a multimodal embedding in a multimodal vector embedding space based on the real-time image and the real-time location data, wherein the multimodal embedding represents a location associated with the real-time location data and includes visual features of the location generated from one or more previous images of the location;
providing the real-time image, the real-time location data, the user query, and the multimodal embedding to a generative AI model with instructions to generate a user query response to the user query based on the multimodal embedding by comparing visual features of the real-time image with the visual features of the location represented by the multimodal embedding; and
providing the user query response to the client device in response to receiving the user query response from the generative AI model.

2. The computer-implemented method of claim 1, further comprising:
generating a real-time embedding from the real-time image and the real-time location data using a multimodal embedding neural network model associated with the multimodal vector embedding space; and
identifying a vector location in the multimodal vector embedding space using the real-time embedding to determine the multimodal embedding in the multimodal vector embedding space.

3. The computer-implemented method of claim 2, further comprising determining the multimodal embedding based on the vector location.

4. The computer-implemented method of claim 3, wherein the multimodal embedding is determined to be closest to the vector location.

5. The computer-implemented method of claim 3, wherein determining the multimodal embedding in the multimodal vector embedding space further comprising:
identifying multiple multimodal embeddings within a threshold distance of the vector location, wherein the multiple multimodal embeddings include the multimodal embedding; and
providing the multiple multimodal embeddings to the generative AI model along with a user query prompt that includes the instructions to generate the user query response.

6. The computer-implemented method of claim 1, wherein the visual features of the location generated from the one or more previous images of the location are generated from one or more previous images captured at the location.

7. The computer-implemented method of claim 6, wherein providing the user query response to the client device further includes providing a text response within a graphical user interface of the client device that displays a copy of the real-time image.

8. The computer-implemented method of claim 2, wherein determining the multimodal embedding in the multimodal vector embedding space further includes determining the multimodal embedding as a closest multimodal embedding to the vector location in the multimodal vector embedding space.

9. The computer-implemented method of claim 1, further comprising:
processing the real-time image to extract visual features of the real-time image; and
providing the visual features of the real-time image with the user query to the generative AI model.

10. The computer-implemented method of claim 1, further comprising:
providing different inputs for a location to a multimodal embedding neural network model, wherein the different inputs are selected from two or more of text information of the location, one or more previous images of the location, entity information of the location, and maps information of the location; and
generating the multimodal embedding of the location using the multimodal embedding neural network model from the different inputs.

11. The computer-implemented method of claim 10, wherein the one or more previous images of the location include one or more aerial images of the location or one or more street-view images of the location.

12. The computer-implemented method of claim 10, wherein providing the multimodal embedding to the generative AI model further comprising:
decoding the multimodal embedding into a natural language narrative, wherein the natural language narrative includes multiple descriptions corresponding to each of the different inputs used to create the multimodal embedding; and
providing the natural language narrative of the multimodal embedding to the generative AI model along with the user query.

13. The computer-implemented method of claim 10, wherein providing the multimodal embedding to the generative AI model further includes providing the multimodal embedding to the generative AI model embedding a feature vector embedding such that the generative AI model uses the feature vector embedding to generate the user query response.

14. The computer-implemented method of claim 13, further comprising providing a system prompt to the generative AI model with the real-time image, the real-time location data, the multimodal embedding, and a user query prompt that includes the user query and the instructions; wherein the system prompt provides additional data handling instructions.

15. The computer-implemented method of claim 1, further comprising:
determining from an external database that fresher location information is available for a location identified in the real-time location data;
requesting the fresher location information from the external database; and
providing the fresher location information to the generative AI model.

16. A computer-implemented method for generating location-based responses from multimodal embeddings using one or more generative artificial intelligence (AI) models, comprising:
receiving a real-time image, real-time location data, and a user query from a client device;
identifying a multimodal embedding in multimodal vector embedding space by using the real-time image and location data, wherein the multimodal embedding represents a location associated with the real-time location data and includes visual features of the location generated from one or more previous images captured at the location;
providing the real-time image, the real-time location data, the user query, and the multimodal embedding to a generative AI model with instructions to generate a user query response based on the multimodal embedding by comparing visual features of the real-time image with the visual features of the location represented by the multimodal embedding, wherein providing the multimodal embedding to the generative AI model further includes providing the multimodal embedding to the generative AI model embedding a feature vector embedding such that the generative AI model uses the feature vector embedding to generate the user query response; and
providing the user query response to the client device in response to receiving the user query response from the generative AI model.

17. The computer-implemented method of claim 16, further comprising:
generating a real-time embedding from the real-time image and the real-time location data using a multimodal embedding neural network model associated with the multimodal vector embedding space; and
identifying a vector location in the multimodal vector embedding space using the real-time embedding to identify the multimodal embedding in the multimodal vector embedding space.

18. The computer-implemented method of claim 17, further comprising determining the multimodal embedding based on the vector location.

19. The computer-implemented method of claim 17, wherein the user query response indicates whether the client device is oriented toward the location represented by the multimodal embedding based on determining whether one or more visual features depicted in the real-time image correspond to one or more expected visual features represented by the multimodal embedding.

20. A system for generating location-based responses from multimodal embeddings using one or more generative artificial intelligence (AI) models, the system comprising:
multimodal vector embedding space that includes a multimodal embedding generated by a multimodal embedding neural network model from two or more different inputs;
generative AI model;
a processing system having a processor; and
a computer memory including instructions that, when executed by the processing system, cause the system to carry out operations comprising:
receiving a real-time image, real-time location data, and a user query from a client device;
determining the multimodal embedding in the multimodal vector embedding space based on the real-time image and the real-time location data, wherein the multimodal embedding represents a location associated with the real-time location data and includes visual features of the location generated from one or more previous images captured at the location, and wherein providing the multimodal embedding to the generative AI model further includes:
decoding the multimodal embedding into a natural language narrative, wherein the natural language narrative includes multiple descriptions corresponding to each of the two or more different inputs used to create the multimodal embedding;
providing the real-time image, the real-time location data, the user query, and the natural language narrative of the multimodal embedding to the generative AI model with instructions to generate a user query response to the user query based on the multimodal embedding by comparing visual features of the real-time image with the visual features of the location described by the natural language narrative of the multimodal embedding; and
providing the user query response to the client device in response to receiving the user query response from the generative AI model.
